(19) United States
(12) Patent Application Publication
(10) Pub. No.: US 2008/0162187 A1
(43) Pub. Date: Jul. 3, 2008

(54) PRESCRIPTION FULFILLMENT APPARATUS AND METHOD

(76) Inventor: Dan G. Starko, Gallatin, TN (US)

Correspondence Address: BAKER, DONELSON, BEARMAN, CALDWELL & BERKOWITZ, SIX CONCOURSE PARKWAY, SUITE 3100, ATLANTA, GA, 30328, US

(21) Appl. No.: 11/618,941

(22) Filed: Jan. 2, 2007

(51) Int. Cl. G06Q 50/00; G06Q 20/00

(52) U.S. Cl. 705/3; 705/40

(57) ABSTRACT

A system for fulfillment by a medical products supplier of medical prescriptions issued by a prescriptionist for patients with reimbursement by a third party provider, in which each patient is provided with a uniquely associated prescription authorization card having an electronically addressable memory encoded by a data station with the medical prescription and communicating the medial prescription to the medical products supplier with a distributor that provides the medical product from the medical products supplier to the patient upon presentation of the prescription authorization card to the distributor, a second data station configured for authenticating the delivery of the medical product to the patient, and a payment transferor for payment for the medical product upon delivery.

### TECHNICAL FIELD

The present invention relates to apparatus and methods for fulfilling medical prescriptions. More particularly, the present invention relates to an integrated system for fulfillment by medical products providers of medical prescriptions issued to patients.

### BACKGROUND

Persons experiencing physical and or mental anomalies frequently are attended by medical physicians for the purpose of diagnosis and treatment. Treatment incorporates a variety of regulated courses or regimen intended to preserve or restore health or to obtain some result such as mitigation, control, or remediation of the underlying matter. Frequently, physicians or prescriptionists prescribe treatments that include the use of medicants at particular specified dosage rates, frequencies, and durations. The physician develops a prescription for addressing the needs of the patient. The physician writes the instructions for the medical prescription on a sheet of a prescription pad. The prescription sheet contains an identification of the physician and the instructions as to the medicant, the amount, the dosage, the frequency, the duration, and special instructions related to the medicant. The patient then undertakes to have the prescription fulfilled at a pharmacy.

There are a variety of pharmacies which provide prescription fulfillment services. These include drug counter services in grocery stores, as well as retail drug stores and apothecaries. In an effort to reduce costs of medicants and fulfillment services, some medical insurance plans provide for a centralized prescription fulfillment center. The original prescription issued by the doctor is delivered by the patient by mail to the central prescription fulfillment center. Thereafter, refills of the prescription (if permitted by the original prescription issued by the physician) can be obtained by telephone or written instruction.

The patient receiving the prescription must also attend to payment for these products. In some instances, payment can be coordinated directly by the physician's staff with the insurance carrier or other funding source. In many instances however, the patient pays the cost of the prescription, and seeks reimbursement from the insurance carrier or other funding entity as appropriate.

While this process provides for delivery of medicants pursuant to written instructions from medical doctors and reimbursement as appropriate, there are drawbacks to this system. Notwithstanding the experience and skill of the pharmacist, the written prescription may be difficult to read leading to errors in dosage, frequency, duration, and special instructions, if not otherwise detected. In addition, there are time delays between the delivery of the prescription to the pharmacist for fulfillment, and availability of the fulfilled prescription. Also, prescription records must be maintained reflecting the medicants ordered, delivered, and paid for, by the prescribing physician, by the pharmacy, and by the funding source.

Accordingly, there is a need in the art for an improved method of medical prescription fulfillment with convenient and secure apparatus readily usable by medical personal, medical prescription suppliers, insurance carriers, and patients. It is to such that the present invention is directed.

### SUMMARY OF THE INVENTION

The present invention meets the need in the art by providing a method for fulfillment of medical prescriptions issued by a prescriptionist for a patient and fulfilled by a medical products supplier, comprising the steps of:

(a) providing a patient with a prescription authorization card having a unique identifier associated with the patient and an electronically addressable memory readable by an electronic sensor that communicates with a remote information center at a medical products supplier;

(b) encoding the electronically addressable memory with a medical prescription for a medical product;

(c) communicating the medical prescription for the medical product for the patient to a remote information center associated with a medical products provider; and

(d) delivering the medical product subject of the medical prescription to the patient.

In another aspect, the present invention provides a system for fulfillment of medical prescriptions issued by a prescriptionist for one of a plurality of patients with reimbursement by a third party provider and fulfilled by a medical products supplier, comprising a plurality of prescription authorization cards that each have a unique identifier associated with one of a plurality of patients for whom medical prescriptions are issued by a prescriptionist and an electronically addressable memory. A first data station is interactively operative for encoding the electronically addressable memory of the prescription authorization card with a medical prescription for the patient by the prescriptionist. A communicator is configured for communicating the medical prescription to a medical products supplier. A distributor provides the medical product subject of the medical prescription from the medical products supplier to the patient. A payment transferor transfers payment for the medical product to the medical product supplier.

Objects, features, and advantages of the present invention will become readily apparent upon reading of the following detailed description in conjunction with the drawings and the appended claims.

### BRIEF DESCRIPTION OF THE DRAWINGS

FIG. 1 illustrates in schematic view an apparatus for medical prescription fulfillment according to the present invention.

FIG. 2 illustrates in schematic view a prescription authorization card for interactive use with the apparatus for medical prescription fulfillment illustrated in FIG. 1.

FIG. 3 illustrates a method for medical prescription fulfillment according to the present invention.

### DETAILED DESCRIPTION

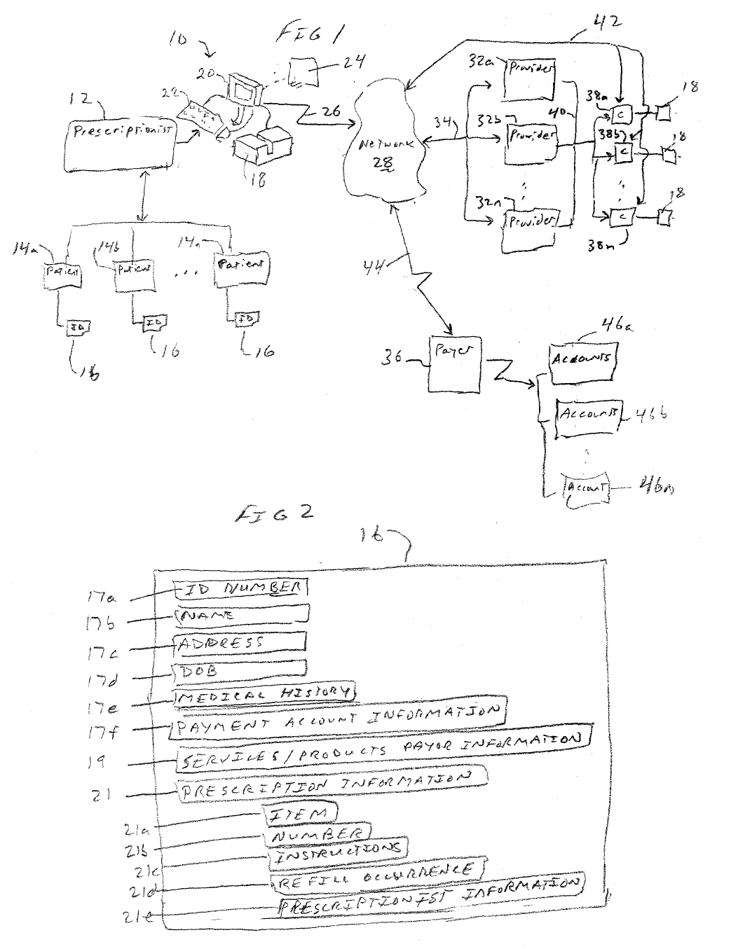

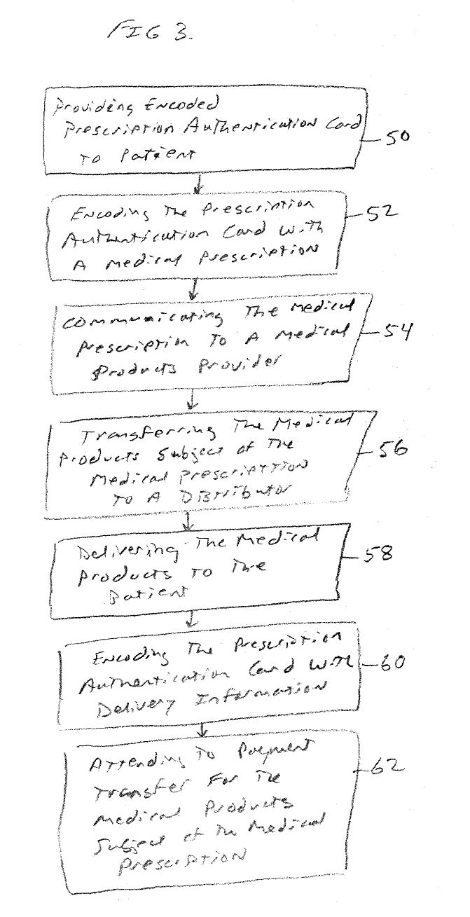

With reference to the drawings in which like reference numerals indicate like parts, FIG. 1 illustrates in schematic view a system 10 for medical prescription fulfillment according to the present invention. The system 10 includes a plurality of prescriptionists 12 (one is illustrated), for example, a treating physician, authorized to issue medical prescriptions to a plurality of patients 14. Each patient 14 is provided with a prescription authorization card 16. As illustrated in schematic view in FIG. 2, the prescription authorization card 16 is encoded with unique information including patient information generally 17, third party information generally 19, and prescription information generally 21 associated with the patient 14. This information includes, for example, an identification number 17a, name 17b, address 17c, date of birth (DOB) 17d, and other pertinent information 17e including as appropriate medical history, allergy and reaction information and other appropriate medically significant information. The patient information 17 for an alternate embodiment a payment account number 17f such as a credit or debit account number for payment of prescription products with the system 10. The prescription authorization card 26 also can contain the identification 19 of the medical services and products payer, such as an insurance carrier or other funding entity to which medical suppliers and providers can seek reimbursement, including address and account numbers as appropriate. The prescription authorization card 26 also contains the prescription information generally 21 including an item identification 21a, an amount 21b, special instructions 21c, refill occurrence availability 21d, and prescriptionist information 21e including name, identification number, contact numbers such as telephone or email, and other appropriate information.

With continuing reference to FIG. 1, the prescription authorization card 16 includes an electronically addressable memory. The patient information 17, the payer information 19, and the prescription information 21 are stored in the memory. The memory in the prescription authorization card 16 is accessible by an electronic device 18 for interactive reading and writing to the card by authorized assessors. Conventional security systems for electronically coded information including passwords, audit tracking, encryption and other techniques, are gainfully employed for confidentiality and control purposes. The electronic device 18 communicates with a microprocessor computer 20 having a conventional keyboard and mouse 22 for input of information by the prescriptionist 12 to a patient management system 24 operated by the computer 20. The computer 20 is configured to communicate by a communications link 26 with a network 28 such as the worldwide web or other network system.

The system 10 includes a plurality of medical products providers generally 32. Each provider 32 communicates by a communications link 34 to the network 28 for interactive communications with prescriptionist 12 and other entities in the system 10 such as a payer 36 and distributors 38. The distributors 38 interact 40 directly with the providers 32 and communicate 42 with the network 28. In one embodiment of the system 10, each distributor 38 includes one of the electronic devices 18 for reading and as appropriate writing to the prescription authorization card 16 of the patient 14. The payer 36 includes a communications link 44 with the network 28 for interactive access to accounts 46 associated with the provider 32 and the distributors 38, as appropriate. The prescription authorization card 26 is accessed for the patient information 17, the payer information 19 and the prescription information 21.

FIG. 3 illustrates a process flow for the method and system for fulfillment of medical prescriptions issued by the prescriptionist 12 for the patient 14, and in an alternate embodiment of the system 10, with reimbursement by a third party to the medical products supplier 32 such as by the payer 36 identified on the prescription authorization card 26 payer information 19. The method provides 50 an encoded prescription authentication card 16 to the patient 14. From time-to-time and as appropriate, the prescriptionist 12 encodes 52 the prescription authentication card 16 with a medical prescription for the patient 14 including the prescription information 21. The electronic device 18 operated by the patient management system 24 enables the prescriptionist 12 to enter using the keyboard and mouse 22 the medical prescription information 19 including the prescription item 21a, the dosage rate and amount 21b, refill authorization 21d, and special instructions 21c such as frequency, duration associated with the medical prescription for the patient 14, and other prescription information as necessary. In addition, the patient management system 24 communicates 54 the medical prescription information 21 to a medical products provider 32. For example, the patient 14 can select a drugstore convenient to the patient's home or business. An information database maintained in a computer complex of the medical products provider 32 receives the medical prescription. In the illustrated embodiment, the patient management system 24 communicates by the link 26 through the network 28 and the links 34 with the medical products provider 32.

The medical products provider 32 uses the medical prescription information in the database and prepares the medical product subject of the medical prescription. The medical products provider 32 transfers 56 the medical products to a distributor 38. The transfer includes a medical prescription report detailing the medicant and instructions by the prescriptionist 12 as to dosage, frequency, duration, refill authorization, and special instructions. It is to be appreciated that the distributor 38 may be a pharmacy service associated with the medical products provider 32, such as a transaction window located at the medical products provider which is accessible to the patient 14. The distributor 38 can also be a pharmacy or a drug store selected by the patient, or a products carrier such as a mail service or delivery service.

The distributor delivers 58 the medical products to the patient. In one aspect of the system 10, the patient provides the prescription authentication card 16 for confirmation of the request for the prescription. The distributor 38 uses the electronic device 18 to authenticate and verify the delivery, and encodes 60 the prescription authentication card 16 with delivery information related to providing the medical products to the patient. Upon delivery, the payments are made for the prescription product. In one aspect, the distributor 38 effects communication through the link 42 and the network 28 to the payer 36 that attends to payment transfer from appropriate accounts 46 for the medical products delivered to the patient 14. In another aspect, the patient 14 may pay the cost directly and seek reimbursement from a third party payer, if available separately.

It is to be appreciated that the encoding step 52 and communicating step 54 may be reversed in order to encode the prescription in the memory of the prescription authentication card 16 following a confirmation from the medical products provider 32 of receipt into the information database of the medical prescription communicated by the prescriptionist 12.

Further, the patient 14 readily accesses the database of the medical products provider 32 to place orders for refills if permitted according to the refill occurrence availability 21d indicated on the prescription authentication card 16. This can be accomplished through interactive access via the network 28 and accessible computer devices and communication channels for accessing web sites on the network, by telephonic interactive identification and confirmation systems, or other communications devices including written media or personal presence. The medical products provider 32 uses the patient information 17 and the prescription information 21 for refill orders, including confirmation with the prescriptionist 12 using the prescriptionist information 21e if necessary.

In another aspect, the prescriptionist information 21e enables billing deductible payments back through the prescriptionist 12 for payment by third party provider. This is accomplished by the distributor communicating with the prescriptionist after delivery of the medical prescription.

The foregoing specification describes the present invention that provides apparatus and method for medical prescription fulfillment. It is to be understood, however, that numerous changes and variations may be made in the construction of the converter within the spirit and scope of the present invention and that modifications and changes may be made therein without departing from the scope thereof as set forth in the appended claims.

What is claimed is:

1. A method for fulfillment of medical prescriptions issued by a prescriptionist for a patient and fulfilled by a medical products supplier, comprising the steps of:
(a) providing a patient with a prescription authorization card having a unique identifier associated with the patient and an electronically addressable memory readable by an electronic sensor that communicates with a remote information center at a medical products supplier;
(b) encoding the electronically addressable memory with a medical prescription for a medical product;
(c) communicating the medical prescription for the medical product for the patient to a remote information center associated with a medical products provider; and
(d) delivering the medical product subject of the medical prescription to the patient.

2. The method as recited in claim 1, further comprising prior to step (d) the step (e) transferring the medical product subject of the medical prescription from the medical products supplier to a distributor.

3. The method as recited in claim 2, further comprising prior to step (d) delivering the steps of:
presenting the prescription authorization card to the distributor, and
authenticating the request for supply of the medical product to the patient.

4. The method as recited in claim 3, further comprising the steps of:
verifying delivery of the medical product to the patient; and
notifying a third party provider of the authentication and delivery of the medical product to the patient for payment.

5. The method as recited in claim 3, further comprising the step of transferring payment from the third party provider to the medical products supplier by electronic funds transfer.

6. The method as recited in claim 5, further comprising the step of encoding the prescription authorization card with an account number from which payment funds are supplied.

7. The method as recited in claim 1, wherein the step (c) encoding comprises moving the prescription authorization card through a writer device configured to communicate the prescription to the addressable memory.

8. The method as recited in claim 1, further comprising the step of marking the medical prescription written in the addressable memory as fulfilled.

9. The method as recited in claim 1 further comprising the step of the patient communicating a request for refill of the medical prescription to the medical products supplier.

10. The method as recited in claim 9, wherein the request includes the unique identifier associated with the patient.

11. The method as recited in claim 9, further wherein the medical products provider communicates the request for refill to the prescriptionist for approval prior to providing the prescribed medical product.

12. A system for fulfillment of medical prescriptions issued by a prescriptionist for one of a plurality of patients with reimbursement by a third party provider and fulfilled by a medical products supplier, comprising:
a plurality of prescription authorization cards, each having a unique identifier associated with one of a plurality of patients for whom medical prescriptions are issued by a prescriptionist and an electronically addressable memory;
a first data station interactively operative for encoding the electronically addressable memory of the prescription authorization card with a medical prescription for the patient by the prescriptionist;
a communicator configured for communicating the medical prescription to a medical products supplier;
a distributor that provides the medical product subject of the medical prescription from the medical products supplier to the patient; and
a payment transferor that transfers payment for the medical product to the medical product supplier.

13. The system as recited in claim 12, further comprising a second data station operatively configured for authenticating the request by the patient to the distributor for supply of the medical product to the patient upon presentation of the prescription authorization card to the distributor.

14. The system as recited in claim 12, further comprising a second communicator configured for communicating selectively between the distributor and the medical products provider or the payment transferor, wherein the payment transferor verifies delivery of the medical product to the patient prior to transfer of the payment to the medical product supplier.

15. The system as recited in claim 12, wherein the distributor is a service associated with the medical products provider.

16. The system as recited in claim 12, wherein the distributor authenticates the request for supply of the medical product to the patient upon presentation of the prescription authorization card to the distributor.

17. The system as recited in claim 16, further comprising a second communicator configured for verifying delivery of the medical product to the patient and notifying a third party provider of the authentication and delivery of the medical product to the patient for payment.

18. The system as recited in claim 17, further comprising an electronic funds transferor for transferring payment from the third party provider to the medical products supplier.

19. The system as recited in claim 18, wherein the prescription authorization card is encoded with an account number from which payment funds are supplied.

20. The system as recited in claim 19, further comprising a writer device configured for encoding the prescription authorization card to the addressable memory.

21. The system as recited in claim 12, wherein the distributor marks the fulfillment of the medical prescription in the addressable memory.

22. The system as recited in claim 12, further comprising a second communicator configured for the patient to communicate a request for refill of the medical prescription to the medical products supplier.

23. The system as recited in claim 22, further comprising the medical products provider communicating the request for refill to the prescriptionist for approval prior to providing the prescribed medical product.
